(19) United States
(12) Patent Application Publication
(10) Pub. No.: US 2004/0077216 A1
(43) Pub. Date: Apr. 22, 2004

(54) USB connector structure with protection means

(75) Inventor: Hsin-Hung Tu, Hsinchu (TW)

Correspondence Address: BRUCE H. TROXELL, SUITE 1404, 5205 LEESBURG PIKE, FALLS CHURCH, VA, 22041, US

(73) Assignee: AIPTEK International Inc.

(21) Appl. No.: 10/272,937

(22) Filed: Oct. 18, 2002

(51) Int. Cl. H01R 13/44

(52) U.S. Cl. 439/607

(57) ABSTRACT

The present invention relates to a USB structure with protection means, especially applying to a USB connector structure without traditional cap but still with protection function. The present invention adopts simple mechanism, spring and positioning structure, pivotal structure and rotational structure, to approach protection object, therefore it saves a lot on cost and manufacturing processes.

### 1. FIELD OF THE INVENTION

The present invention relates to a USB connector structure with protection means, especially applying to a USB connector structure without traditional cap but still with protection function.

### 2. BACKGROUND OF PRIOR ART

For the past several years, USB has being applied to the field of data communication. It is just because of its functions of fast communication speed, plug and play (PnP) and no need to restart computer, and the peripheral is then brought to a new application century, such as CD-ROM, CD Recorder, mobile hard disk, digital recorder, digital camera, digital camcorder, etc. Thus, as we can see, the USB application is already around anywhere to us.

The storing interfaces of hard disk in a PC or a mobile computer, MO, floppy disk (1.4 MB), CD (600 MB) CD-RW, etc. are different, and those are disadvantageous for carrying, storing and cost. Gradually, a new product is then generated, called thumb drive, which is specially for being carried data. The thumb drive has the features of enough capacity, fast communication, easy carrying, low cost, etc., and they totally break through the bottleneck for earlier computer peripheral storing data.

Please refer to FIG. 1, which is a schematic diagram of a USB plug in prior art. Normally there is a cap 11 to protect a USB connector 13. After the cap 11 covering on the USB connector 13, a figure of the cap 11 is just matched with a figure of a case 15, and it seems like they become one body. The body can protect both the USB connector 13 and electrical parts (not shown in figure). During usage, cap 11 may be taken off from the case 15 and easily lost. Once cap 11 is lost, USB connector 13 may then be simply damaged. Hence, how to improve the disadvantage in prior art is the major discussion of the present invention.

### SUMMARY OF THE INVENTION

The major object of the present invention is to provide a USB connector structure with protection means to protect the USB connector, further to avoid loosing protection means in prior art.

The secondary object of the present invention is to provide a USB connector structure with protection means to extend the lifetime of the USB connector, further to decrease user's cost.

To further understand and recognize the object, function and characteristic of the present invention, the esteemed review committee members please refer to the detailed description and corresponding diagrams of the present invention as following:

### BRIEF DESCRIPTION OF THE DRAWINGS

FIG. 1 is a schematic diagram of a USB plug in prior art.

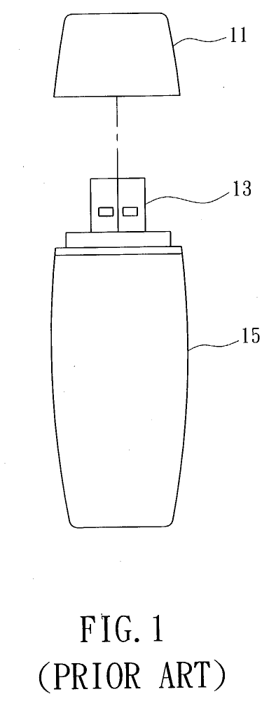

FIGS. 2A and 2B are the first embodiment of the present invention.

FIGS. 3A and 3B are the second embodiment of the present invention.

FIGS. 4A and 4B are the third embodiment of the present invention.

FIGS. 5A and 5B are the fourth embodiment of the present invention.

FIGS. 6A and 6B are the fifth embodiment of the present invention.

### DETAILED DESCRIPTION OF THE PREFERRED EMBODIMENTS

The present invention has being provided for business application and protection from patent law.

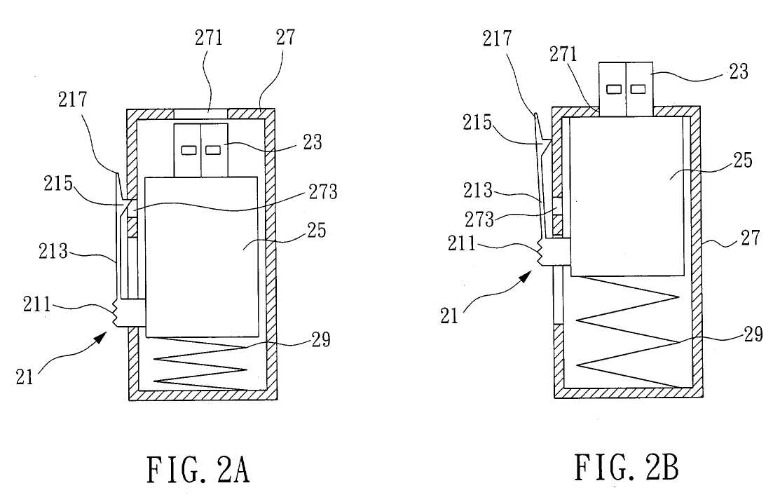

Referring to FIG. 2, which is the first embodiment of the present invention. FIG. 2A shows a USB connector 23 being fit into a case 27; the USB connector 23 connects to a PCB 25, and a bottom of the PCB 25 has a spring 29 for withstanding between the bottom of the PCB 25 and an internal surface of a bottom of the case 27. Meanwhile the spring 29 is depressed by a positioning structure 21. A buckling piece 215 inserts into a buckling hole 273, other components as a poking piece 217, an extended arm 213 and a pushing button 211 are actually with the buckling piece 25 in one body so as to keep the PCB 25 staying with the present status. When the poking piece 217 is poked up, the buckling piece 215 is then taken off from the buckling hole 273, shown as FIG. 2B; continuously USB connector 23 is protruded out from a USB exit 271.

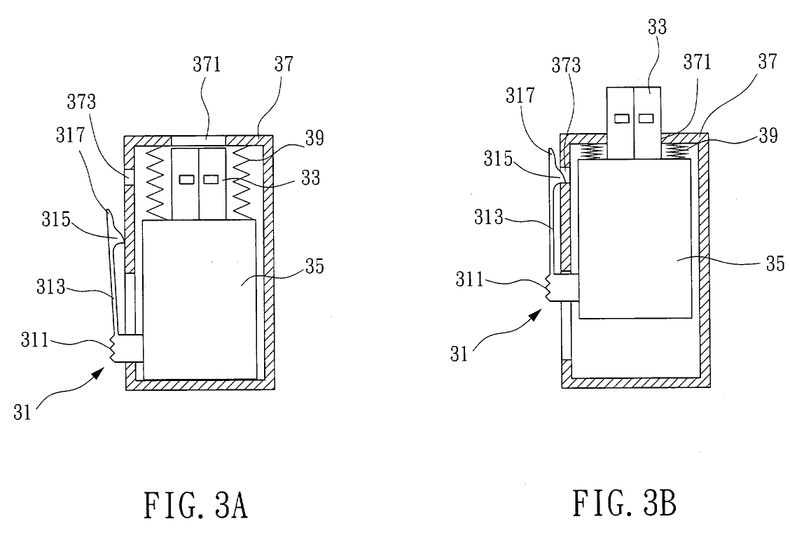

Referring to FIG. 3, which is the second embodiment of the present invention. FIG. 3A shows a USB connector 33 being hidden in a case 37; the USB connector 33 connects to a PCB 35, and a top of the PCB 35 has a plurality of springs 39 for withstanding between an internal surface of a top of the case 37 and the top of PCB 35. Meanwhile the springs 39 are elongated. Depressing and pushing a pushing button 311 of a positioning structure 31 upward makes that a buckling piece 315 being inserted into a buckling hole 373 because of the pushing button 311, an extended arm 313 and the buckling piece 315 are in one body; on the other hand, pushing button 311 connects with PCB 35 so as to that USB connector 33 is protruded out from a USB exit 371, shown as FIG. 3B. At the moment, the springs 39 are depressed, and slightly poking up a poking piece 317 to take buckling piece 315 off the buckling hole 373 for recovering back to the status shown as FIG. 3A via spring force.

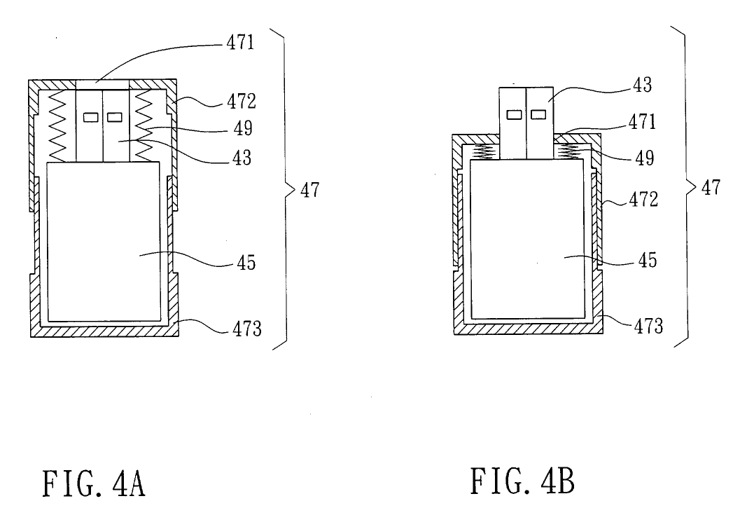

Referring to FIG. 4, which is the third embodiment of the present invention. As shown in FIG. 4A, a case 47 comprises a fixing case 473 and a moving case 472. An upper part of the fixing case 473 are wrapped in the moving case 472, and moving case 472 is capable of sliding up and down on fixing case 473. In the meantime, plural springs 49 withstand between a PCB 45 and a top of moving case 472 and are in elongation. To press moving case 472 downward is to let that a USB connector 43 goes out of moving case 472 via a USB exit 471, as shown in FIG. 4B.

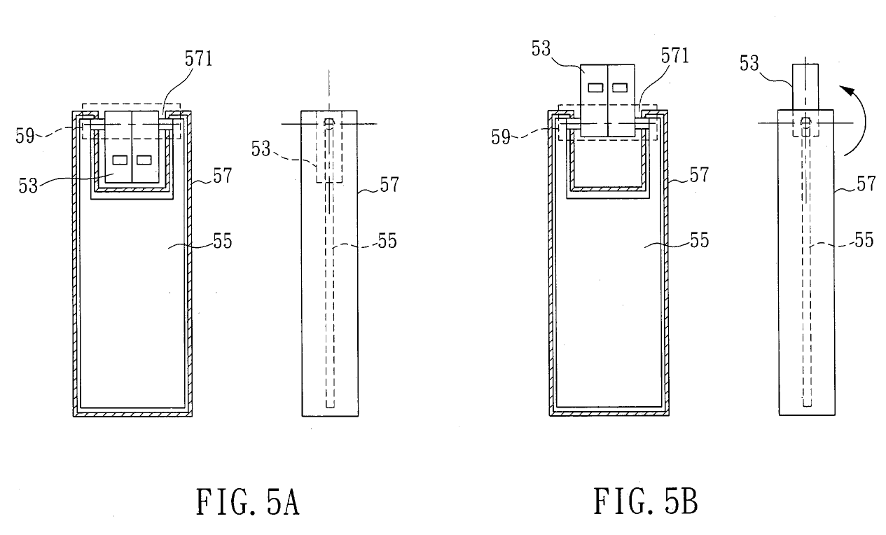

Referring to FIG. 5, which is the fourth embodiment of the present invention. As shown in FIG. 5A, a USB connector 53 is hidden in an empty place of a case 57. The USB connector 53 pivots on a PCB 55 via a pivotal structure 59 for both structure connection and electrical connection, such as pivotal means of keyboard and LCD of general portable computer, and there are several wires in the pivotal means. The pivotal structure 59 is able to have pivotal connection with USB connector 53 for turning USB connector 53 over so as to that USB connector 53 being protruded out from a USB exit 571, as shown in FIG. 5B.

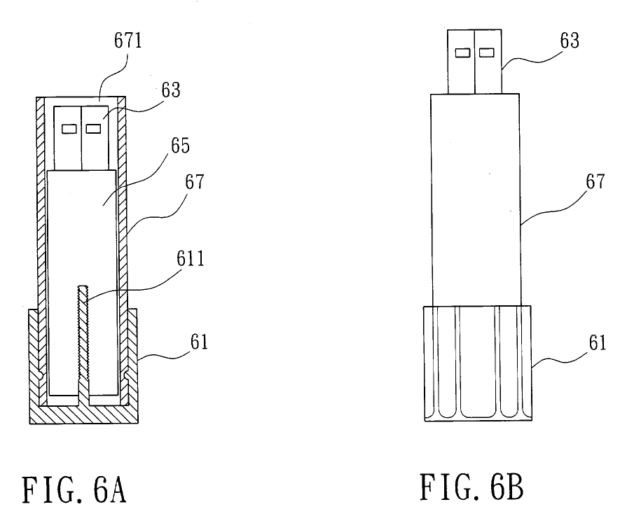

Referring to FIG. 6, which is the fifth embodiment of the present invention. The embodiment adopts a screw mechanism to protrude a USB connector out of a case. As shown in FIG. 6A, a USB connector 63 connects with a PCB 65, which lodges with a guiding rod 611; namely the PCB 65 has a toothlike structure, which is just matched with the guiding rod 611. A rotational base 61 wraps over a bottom of a case 67, and a protruding object on the rotational base 61 cooperates with a slot on the case 67 to make that rotational base 61 can circulate on case 67. Guiding rod 611 and rotational base 61 are in the same body, rotational base 61 is able to move PCB 65 and the USB connector 63 up and down via guiding rod 611; continuously USB connector 63 goes out of case 67 through a USB exit 671.

To conclude the above embodiments, the present invention adopts simple design to approach the protection purpose, such as spring and positioning structure, pivotal structure and rotational structure. As it can be seen, the present invention is capable of saving cost and manufacturing processes.

The above-descriptions are the preferable embodiments of the present invention, however, the covered scope of the present invention is not limited to the embodiments shown in this invention. Any changes according to the content of the present invention and the resulted functions and characteristics are similar to the embodiments of the present invention and the ideas created by all such technology well-known persons are all belonged to the covering scopes of the present invention.

What is claimed is:

1. A USB connector structure with protection means, an end of said USB connector structure connecting with an electrical means, said protection means comprising:
at least one case, USB connector structure being hidden in one end of said case, both USB connector structure and said electrical means axially moving in case, an exit being on said end of case for USB connector structure protruding out of case;
at least one positioning structure, which connecting with electrical means and being on outside of case for USB connector structure moving from one end of case to another.

2. The USB connector structure with protection means as cited in claim 1, further installing at least one elastic component in case, and USB connector structure can move via elasticity of the elastic component.

3. The USB connector structure with protection means as cited in claim 2, the elastic component is installed on an opposite end of the end with said exit of case.

4. The USB connector structure with protection means as cited in claim 2, the elastic component is installed among the electrical means, USB connector and the end with said exit of case.

5. The USB connector structure with protection means as cited in claim 3, when elastic component being depressed may be temporarily kept a status of depression by said positioning structure, on the other hand, releasing positioning structure to discard the status of depression for USB connector structure protruding out of case through exit.

6. The USB connector structure with protection means as cited in claim 4, when elastic component being depressed may be temporarily kept a status of depression by said positioning structure, USB connector structure is then protruded out of case through exit and positioned, on the other hand, releasing positioning structure to discard the status of depression for USB connector structure hiding in said end of case.

7. A USB connector structure with protection means, an end of said USB connector structure connecting with an electrical means, said protection means comprising:
two cases, USB connector structure and said electrical means being contained in a first case, a second case being on a position corresponding to first case so as to form a whole case for wrapping up USB connector structure and electrical means, said second case having an exit and both cases being able to slide each other for USB connector structure protruding out of second case.

8. The USB connector structure with protection means as cited in claim 7, a plurality of elastic components support between electrical means and second case, while elastic components being depressed, USB connector structure is protruded out of second case through said exit, on the other hand, while elastic components being released, USB connector structure is hidden into second case.

9. A USB connector structure with protection means comprising:
one electrical means, said USB connector structure being hidden in one end of said electrical means and connected to electrical means by pivotal means.

10. The USB connector structure with protection means as cited in claim 9, wherein USB connector structure electrically connects to electrical means via said pivotal means.

11. The USB connector structure with protection means as cited in claim 9, wherein electrical means can be contained in a case.

12. A USB connector structure with protection means, an end of said USB connector structure connecting with an electrical means, said protection means comprising:
at least one case, USB connector structure being hidden in one end of said case, both USB connector structure and said electrical means axially moving in case, an exit being on said end of case for USB connector structure protruding out of case;
a rotational means being installed on an opposite end of end with said exit and connecting to electrical means via a guiding means, said rotational means then driving electrical means.

13. The USB connector structure with protection means as cited in claim 12, wherein guiding means is a guiding rod.
